(19) United States
(12) Patent Application Publication
(10) Pub. No.: US 2026/0350156 A1
(43) Pub. Date: Nov. 5, 2026

(54) HARDWARE ANOMALY DETECTION USING PROPERTY ENFORCEMENT

(71) Applicants: Eaton Intelligent Power Limited, Dublin 4 (IE); Rochester Institute of Technology, Rochester, NY (US)

(72) Inventors: Ajesh Koyatan Chathoth, Mc Donald, PA (US); Michael Jeffrey Zuzak, Hilton, NY (US)

(21) Appl. No.: 19/552,810

(22) Filed: Feb. 27, 2026

Related U.S. Application Data
(60) Provisional application No. 63/797,578, filed on Apr. 30, 2025.

(51) Int. Cl. G06F 21/55; G06F 21/54; G06N 20/10

(52) U.S. Cl. CPC G06F 21/554; G06F 21/54; G06N 20/10

(57) ABSTRACT

A system may initialize a hardware watchdog timer configured to perform a remedial action unless the hardware watchdog timer is reset by a security confirmation signal before a predetermined time period expires. The system may initialize a timer for triggering non-maskable interrupts at predetermined intervals. The system may trigger, based on the timer, a first non-maskable interrupt before the predetermined time period of the hardware watchdog timer expires. The system may invoke an interrupt handler to handle the first non-maskable interrupt, wherein the interrupt handler is configured to obtain a state of the processor and check a set of predefined logical security properties against the state of the processor to determine whether a security requirement is satisfied or unsatisfied. Upon a determination that the security requirement is satisfied, the system sends the security confirmation signal to reset the hardware watchdog timer, thereby preventing the remedial action from being performed. Upon a determination that the security requirement is unsatisfied, the system refrains from sending the confirmation signal to the hardware watchdog timer, thereby allowing the hardware watchdog timer to perform the remedial action upon expiration of the predetermined time period.

### PRIORITY

This application claims the benefit under 35 U.S.C. § 119(e) of U.S. Provisional Patent Application No. 63/797,578, filed 30 Apr. 2025, which is incorporated herein by reference.

### TECHNICAL FIELD

The present disclosure generally relates to computing system security, and more specifically to methods and systems for detecting operational anomalies indicative of potential compromises of computing systems.

### BACKGROUND

Computing and embedded devices are increasingly utilized across a wide range of applications. These devices frequently handle sensitive data and/or execute safety-critical operations, rendering them prime targets for both software-based and hardware-based attacks. As a result, establishing and maintaining the trust and security of such devices is critical.

To protect computing devices from attacks, cybersecurity safeguards and countermeasures are often implemented into chipsets. However, such hardware-level security features are costly and designed based on known threats. Products/devices shipped with such chipsets remain vulnerable to zero-day exploits (i.e., attacks that have never been seen before) or via a hidden backdoor that was never discovered until after product shipment. Thus, it is important for devices to at least be able to detect anomalous behaviors after the devices have been put into operation so that any remediating action can be taken at runtime.

Unfortunately, due to tight design and cost constraints, low-end processor units generally lack the hardware security features available in more resource-rich systems, such as trusted execution environments and process isolation. This limitation has prompted the development of alternative trust and security mechanisms tailored for resource-constrained systems. Prior research has demonstrated that the assumptions underpinning purely software-based attestation schemes are generally impractical in real-world deployments. As a result, most practical solutions adopt hardware-assisted or co-designed approaches that integrate custom hardware components to support anomaly detection and establish trust. These hardware modifications, however, are often infeasible for low-end processors for two main reasons: (1) the cost of implementing such mechanisms can be impractically high, and (2) application developers may lack the necessary capabilities or design details to perform a system re-design.

Thus, there is an industry need for a security mechanism that can reliably detect, at runtime, hardware anomalies and zero-day exploits in resource-constrained devices.

### SUMMARY OF PARTICULAR EMBODIMENTS

The disclosed embodiments leverage a hardware watchdog (HWD) timer to ensure security properties are periodically checked/enforced. A HWD is an always-on hardware timer that must be periodically reset (“fed”) to avoid a mandatory system reset. These timers are standard in most low-end processors. They are enabled at system startup during secure boot, and cannot be disabled thereafter.

To periodically feed the HWD, a non-maskable interrupt (NMI) will be configured to run at regular intervals. This interrupt will trigger a handler that checks a set of predetermined logical security properties against the processor state. The NMIs may be periodically generated by a hardware-based interrupt request. These security properties may be logical formulas which characterize secure processor states. They are evaluated in the NMI handler and assess the security-relevant state of the processor (e.g., link register (LR), program counter (PC), configuration registers, etc.) using these formulas. If none of the properties are violated, the interrupt handler sends a security confirmation signal to “feed” the HWD timer; otherwise, the HWD times-out, initiating a mandatory shutdown sequence and notifying the user of the violated security property. By doing so, the HWD provides hardware assistance to ensure that security properties are periodically enforced without custom hardware redesign.

The clauses below summarize various embodiments described herein.

Clause 1. A method for detecting hardware anomalies in a processor, the method comprising: initializing a hardware watchdog timer configured to perform a remedial action unless the hardware watchdog timer is reset by a security confirmation signal before a predetermined time period expires; initializing a timer for triggering non-maskable interrupts at predetermined intervals; triggering, based on the timer, a first non-maskable interrupt before the predetermined time period of the hardware watchdog timer expires; invoking an interrupt handler to handle the first non-maskable interrupt, wherein the interrupt handler is configured to: obtain a state of the processor; check a set of predefined logical security properties against the state of the processor to determine whether a security requirement is satisfied or unsatisfied; upon a determination that the security requirement is satisfied, send the security confirmation signal to reset the hardware watchdog timer, thereby preventing the remedial action from being performed; and upon a determination that the security requirement is unsatisfied, refrain from sending the confirmation signal to the hardware watchdog timer, thereby allowing the hardware watchdog timer to perform the remedial action upon expiration of the predetermined time period.

Clause 2. The method of clause 1, wherein the hardware watchdog timer is enabled during startup of the processor and cannot be disabled during operation of the processor.

Clause 3. The method of any one of the preceding clauses, wherein the remedial action comprises a forced reset of the processor.

Clause 4. The method of any one of the preceding clauses, wherein the security confirmation signal is sent by the interrupt handler to the hardware watchdog timer via a second non-maskable interrupt.

Clause 5. The method of any one of the preceding clauses, wherein the security properties are configurable and stored in protected memory accessible by the processor.

Clause 6. The method of any one of the preceding clauses, further comprising: invoking, at predetermined second intervals, a machine-learning model to determine whether the processor is in a secure state or an anomalous state; and in response to the machine-learning model determining that the processor is in an anomalous state, logging data associated with the processor.

Clause 7. The method of clause 6, wherein the machine-learning model is trained using training data obtained from one or more processors operating in a secure state and not using any training data from any processor operating in an anomalous state.

Clause 8. The method of any one of clauses 6-7, wherein the machine-learning model is a one-class support vector machine.

Clause 9. The method of any one of clauses 6-7, wherein the machine-learning model is an autoencoder.

Clause 10. The method of any one of clauses 6-9, wherein the predetermined second intervals for invoking the machine-learning model has a lower frequency than the predetermined intervals for triggering the non-maskable interrupts.

Clause 11. The method of any one of the preceding clauses, wherein the interrupt handler is further configured to determine whether the security requirement is satisfied or unsatisfied by using a machine-learning model to determine whether the processor is in a secure state or an anomalous state.

Clause 12. A system comprising: a hardware watchdog timer configured initialize upon startup of the system and to perform a remedial action unless the hardware watchdog timer is reset by a security confirmation signal before a predetermined time period expires; one or more non-transitory computer-readable storage media including instructions; and one or more processors coupled to the one or more non-transitory computer-readable storage media, the one or more processors configured to execute the instructions to: initialize a timer for triggering non-maskable interrupts at predetermined intervals; trigger, based on the timer, a first non-maskable interrupt before the predetermined time period of the hardware watchdog timer expires; invoke an interrupt handler to handle the first non-maskable interrupt, wherein the interrupt handler is configured to: obtain a state of the one or more processors; check a set of predefined logical security properties against the state of the one or more processor to determine whether a security requirement is satisfied or unsatisfied; upon a determination that the security requirement is satisfied, send the security confirmation signal to reset the hardware watchdog timer, thereby preventing the remedial action from being performed; and upon a determination that the security requirement is unsatisfied, refrain from sending the confirmation signal to the hardware watchdog timer, thereby allowing the hardware watchdog timer to perform the remedial action upon expiration of the predetermined time period.

Clause 13. The system of clause 12, wherein the hardware watchdog timer cannot be disabled during operation of the one or more processors.

Clause 14. The system of any one of clauses 12-13, wherein the remedial action comprises a forced reset of the one or more processor.

Clause 15. The system of any one of clauses 12-14, wherein the security confirmation signal is sent by the interrupt handler to the hardware watchdog timer via a second non-maskable interrupt.

Clause 16. The system of any one of clauses 12-15, wherein the one or more processors are further configured to execute the instructions to: invoke, at predetermined second intervals, a machine-learning model to determine whether the processor is in a secure state or an anomalous state; and in response to the machine-learning model determining that the processor is in an anomalous state, log data associated with the processor.

Clause 17. The system of any one of clauses 12-16, wherein the machine-learning model is trained using training data obtained from one or more processors operating in a secure state and not using any training data from any processor operating in an anomalous state.

Clause 18. The system of any one of clauses 12-17, wherein the machine-learning model is a one-class support vector machine.

Clause 19. The system of any one of clauses 12-17, wherein the machine-learning model is an autoencoder.

Clause 20. The system of any one of clauses 12-19, wherein the predetermined second intervals for invoking the machine-learning model has a lower frequency than the predetermined intervals for triggering the non-maskable interrupts.

### BRIEF DESCRIPTION OF THE DRAWINGS

The present invention will be described in greater detail below based on the exemplary figures. However, it should be noted that the concepts contemplated herein are not limited to the exemplary embodiments. Other features and advantages of various embodiments of the present invention will become apparent by reading the following detailed description with reference to the figures.

FIG. 1 illustrates an example embodiment of a processor implementing a hardware watchdog assisted security property enforcement mechanism.

FIG. 2 illustrates an example of a timing diagram corresponding to normal operation of an processor implementing hardware-watchdog-assisted security property enforcement.

FIG. 3 illustrates an example timing diagram corresponding to a failure scenario in which a security property check is bypassed or disabled, thereby preventing execution of the security property verification process.

FIG. 4 illustrates an example timing diagram corresponding to a scenario in which one or more security properties are violated.

FIG. 5 is a flow diagram illustrating a hardware watchdog assisted security property enforcement process, according to particular embodiments.

FIG. 6 illustrates an example computer system that may be used in performing one or more of the foregoing techniques as presently disclosed herein.

### DESCRIPTION OF EXAMPLE EMBODIMENTS

In safety-critical and security-sensitive applications, it is often necessary to establish trust in the correct operation of a computing device deployed in the field. In particular, low-end processors are increasingly used in environments where failures or malicious behavior may have significant consequences. As a result, a variety of techniques have been developed to detect anomalies and to verify the integrity of software executing on such devices.

One class of existing solutions includes remote attestation (RA) mechanisms. Remote attestation generally refers to a challenge-response protocol in which a trusted verifier assesses the integrity of a remote device, referred to as a prover. In a typical remote attestation process, the verifier issues a challenge requesting proof of integrity, the prover computes an authentication value over a predefined region of memory in response to the challenge, and the resulting response is returned to the verifier for validation. If the response matches an expected value, the verifier concludes that the device memory has not been altered.

Remote attestation techniques have been shown to be effective in detecting a variety of attacks, including both data-oriented and control-flow-oriented attacks. Such techniques may be implemented using hardware-based mechanisms, software-based mechanisms, or hybrid approaches that combine hardware and software support. However, these existing approaches present significant limitations in the context of low-end processors. Hardware-based attestation mechanisms often require additional components or design changes that increase cost and complexity, making them impractical or cost-prohibitive. Software-only approaches, while avoiding hardware modification, generally depend on strong assumptions, which may not hold in real-world deployments. Even hybrid approaches that have been adapted for low-end processors inherently require some degree of dedicated hardware support, making such solutions impractical or overly costly.

Another approach to anomaly detection in processors employs dedicated hardware support to enforce a security policy on a system, referred to as hardware property enforcement. Integrating such hardware requires modifying the processor pipeline to automatically check a logical security policy and repair any violations at runtime. While such approaches are effective, they rely on hardware modification, which may be infeasible for low-end processors.

While both remote attestation and hardware property enforcement ensure processor trust and integrity, they require dedicated hardware support and may necessitate redesigning parts of the pipeline. Re-architecting processor hardware for specific applications is costly and often infeasible, especially for low-end hardware. Thus, the embodiments described herein aim to adapt these approaches to develop a generic security mechanism that provides hardware-assisted enforcement without custom hardware support.

The disclosed embodiments provide a property enforcement mechanism that does not require custom hardware redesign. One of the main challenges is ensuring the execution of the security mechanism. Thus, one objective of the security measures described herein is to ensure that a trust mechanism remains active and cannot be disabled without proper authorization, even in situations where an adversary gains control of the processor. In certain embodiments, this is achieved using a hardware watchdog (HWD) timer, which enforces periodic checks of security properties. A HWD is an always-on hardware timer that must be periodically reset (or “fed”) within a specific time window by a designated source. This allows periodic security property checks to be linked to feeding the HWD, thereby ensuring that the security mechanism remains active and the processor continuously enforces its security policy. Any violation or failure to run security property checks will result in a HWD time-out, forcing a mandatory reset of the processor or triggering some other remediating action (e.g., repairing the state). This guarantees that security properties are always periodically enforced on the system.

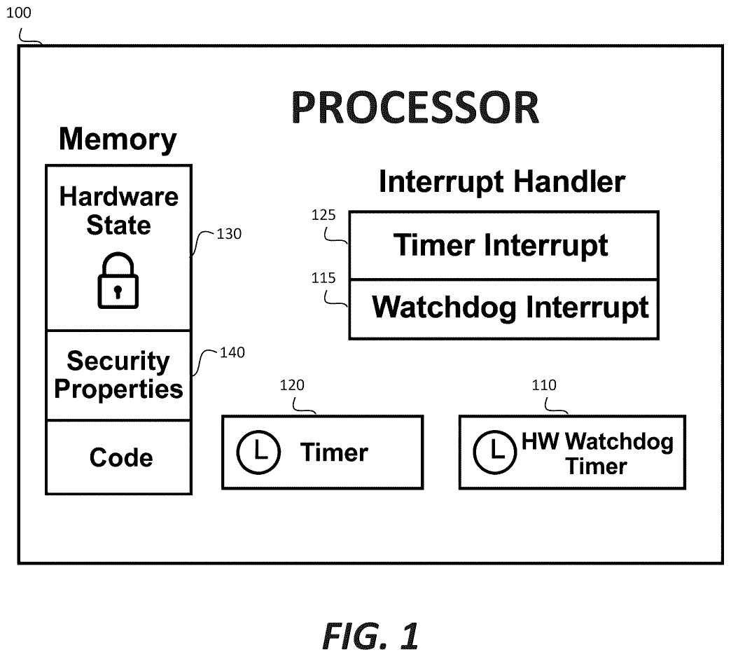

FIG. 1 illustrates an example embodiment of a processor 100 implementing a hardware-watchdog-assisted security property enforcement mechanism. The processor 100 includes a hardware watchdog (HWD) timer 110, which is a standard component in many processors, including low-end devices, and which cannot be disabled after activation. The conventional purpose of these timers is to maintain system stability by ensuring the processor is responsive. However, in the context of the present disclosure, the HWD timer 110 is being leveraged to support security property enforcement via periodic checks.

In the embodiments described herein, the HWD timer 110 serves as a mechanism for enforcing periodic verification of one or more security properties of the processor 100. The HWD timer 110 is an independent hardware circuit that monitors system operation by maintaining a hardware countdown timer that must be periodically refreshed by software during normal execution. In some embodiments, the HWD timer 110 is enabled as early as possible during the boot process, such as during execution of a first-stage bootloader, and cannot be disabled thereafter. Once enabled, the HWD timer 110 operates as an always-on hardware timer that must be periodically “fed” to prevent a mandatory system reset. When used in the security context, the HWD timer 110 is configured to require confirmation that the security properties remain intact within a configured time interval, thereby providing a persistent enforcement mechanism for security policies. Failure to perform required security checks, or detection of a violation of a security property, results in expiration of the HWD timer 110 and initiation of a remedial action, such as a system reset or restoration to a known good state, which can be customized for specific applications. For example, a watchdog interrupt 115 is a signal generated by the HWD timer 110 upon expiration of the countdown period. The watchdog interrupt 115 notifies the processor 100 of a potential system fault and may allow software to perform diagnostic logging, attempt recovery, or place the system into a safe state. In this manner, the disclosed system ensures that security properties are continuously and periodically enforced, even in the presence of compromised software execution.

It is worth noting that the HWD timer 110 operates independently of the main processor and executing software, ensuring continued operation even if the processor or software stack is compromised. Unlike software-implemented watchdog mechanisms, which may be disabled or bypassed by an adversary with control over program execution, the HWD timer 110 cannot be compromised through software attacks. As a result, expiration of the HWD timer 110 reliably triggers a corrective action when security checks are not successfully completed, thereby guaranteeing continued enforcement of security properties throughout device operation.

As discussed, the HWD timer 110 must be periodically “fed” to avoid a system reset or remediation action. In particular embodiments, the HWD 110 is fed when a set of security properties 140 has passed certain predefined security requirements. In certain implementations, the mechanism for running periodic security checks and feeding the HWD is implemented using a non-maskable interrupt (NMI), which is a type of interrupt signal in a processor that cannot be disabled, ignored, or masked by normal software-controlled interrupt settings. NMIs are reserved for handling critical events that require immediate attention, regardless of the current execution state of the system. When an NMI is asserted, program execution is immediately diverted to a predefined interrupt service routine, allowing the system to perform diagnostic actions, initiate recovery procedures, or transition to a safe state. The non-maskable nature of the interrupt ensures that these critical events are handled even if the processor is executing faulty, compromised, or unresponsive software.

In particular embodiments, in addition to initiating the HWD timer 110, the processor 100 initiates an interrupt timer 120 for triggering a periodic non-maskable interrupt (NMI) 125. The interrupt timer 120 may be implemented in hardware or software, and the time interval for triggering an NMI 125 may be customized depending on the application (e.g., more frequent checks improve security but introduces additional overhead on the computational resources of the system).

The NMI 125 triggers an interrupt handler configured to evaluate a set of predefined logical security properties 140 against the processor's current state 130. These security properties 140 may be any suitable logical formulas that characterize and evaluate whether the processor's states 130 are secure. In other words, the security properties 140 define security invariants that must be true if the system is in a secure state. For example, the security properties 140 may define acceptable system states 130 of the processor that may include, but is not limited to, link register (LR), program counter (PC), hardware configuration registers, trust-critical memory regions, or any other metadata related to the processor's operational state. In certain embodiments, the security state analyzed may be limited to the processor's operational state, excluding application data or application states. These properties may be user-defined or determined per device based on the application or system requirements and can be expandable/adjustable.

If the security properties 140 satisfy the system's security requirements, the NMI handler will “feed” the HWD timer 110 by signaling to it that the security properties are still intact (i.e., the handler will send a security confirmation signal to the HWD timer 110, informing it that the security properties have been satisfied). In response, the HWD timer 110 will reset its timer to allow the processor 100 to resume normal operation for the time being and wait to be fed again until the timer expires. Conversely, if the security requirements are unsatisfied by the security properties 140, the NMI handler will not “feed” the HWD timer 110. As a result, the HWD timer 110 will expire or time out, which in turn may trigger a watchdog interrupt 115 to initiate mandatory remediation actions. The remediation actions could include anything that the device manufacturer or user deems appropriate when the device is behaving anomalously. For example, the remediation actions may include, e.g., a shutdown sequence and/or a notification identifying the violated security property. This approach enables periodic, hardware-assisted enforcement of security policies without requiring custom hardware redesign.

The security mechanism discussed so far does not preclude the possibility of an adversary disabling property checking and feeding the HWD timer directly. Mechanisms to mitigate this include using a trusted interrupt (e.g., secure interrupts) or requiring handlers with higher privileges to feed the HWD timer. An off-chip HWD timer using a cryptographic nonce or device secret could also prevent unauthorized feeding.

The security mechanism described herein can be used to detect and react to security compromises in any processor. Both software (e.g., malicious code execution) and hardware (e.g., fault injection) attack modalities are within scope. The adversary's objective is to maliciously modify the configuration or state of the victim processor. More formally, an attack success may be considered as any modification of a protected processor state or memory. The attacker can employ any strategy. For example, one type of attack may include physical access to a functional, deployed version of the processor. The adversary can interact with the processor to understand its operation, including input-output behavior. Another example of an attack may involve network access to the device, including the ability to read and write packets to the device network. Yet another example may include the ability to interact with communication interfaces, such as Joint Test Action Group (JTAG), Inter-Integrated Circuit protocol (I2C), etc. The ability to use these interfaces does not imply that the data will be processed. A successful defense should detect any in-scope attack and notify the user of a security violation under tight time constraints. Examples of such in-scope attack may include one or more of the following non-limiting examples: stack-based buffer overflow; improper access control; improper privilege management; embedded malicious code; improper access control for on-chip debug; improper prevention of lock bit modification; security-sensitive hardware controls with missing protection; use of a cryptographic primitive with a risky implementation, asset exposed to unsafe debut access; improper restriction of software interface to hardware; improper handling of memory overlap; sensitive information uncleared before state transition; and improper access control for memory containing boot code.

The functionality of HWD-assisted property enforcement can be represented with timing diagrams that illustrate the interactions between the prover (e.g., the processor core) and the verifier (e.g., the HWD timer and property enforcement NMI). To outline the intended functionality, we discuss three cases, one where the processor functions as intended and two where anomalous behavior is present in the device. In each case, we assume the processor 100 is already booted and running.

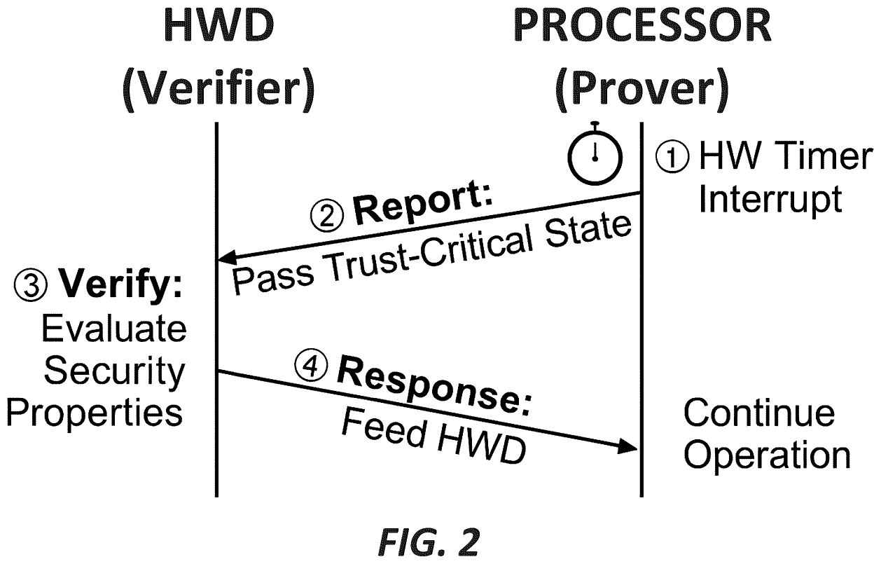

FIG. 2 illustrates an example of a timing diagram corresponding to normal operation of an processor implementing hardware-watchdog-assisted security property enforcement. The illustrated timing sequence occurs after the hardware watchdog (HWD) timer 110 has been enabled and its countdown has commenced. Operation proceeds as follows. At step (1), a hardware timer 120 generates a periodic NMI interrupt 125 requesting verification of one or more predefined security properties 140. At step (2), the processor 100 services the NMI 125 by ceding execution control to an interrupt handler and reporting its current operational state 130. At step (3), the interrupt handler evaluates the processor state 130 and memory contents by checking the predefined logical security properties 140. In the illustrated normal-operation scenario, the security properties are satisfied. Accordingly, at step (4), the interrupt handler sends a security confirmation signal, or “feeds,” the HWD timer 110 to prevent expiration. Control is then returned to the processor, which resumes normal execution until a subsequent verification request is triggered.

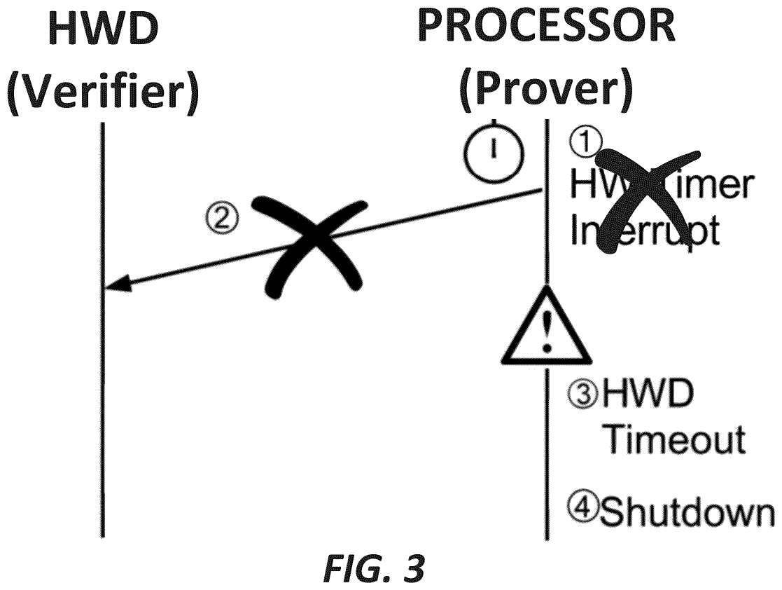

FIG. 3 illustrates an example timing diagram corresponding to a failure scenario in which a security property check is bypassed or disabled, thereby preventing execution of the security property verification process. As in FIG. 2, the illustrated timing sequence occurs after the hardware watchdog (HWD) timer 110 has been enabled during secure boot and its countdown has commenced. In the illustrated scenario, the processor 100 is subject to an attack that results in an unauthorized change to hardware or execution state. Although an attacker operating at runtime is generally unable to modify the interrupt vector table—which defines the addresses used by the processor 100 to invoke interrupt handlers—the attacker may nevertheless disable or bypass the interrupt timer 120 responsible for triggering the periodic NMI 125. This is illustrated in FIG. 3 by the crossing-out of step (1), indicating that the timer 120 never triggers. As a result, the NMI 125 is prevented from invoking the interrupt handler that performs the security property check (illustrated by step (2) being crossed-out). Because the HWD timer 110 cannot be disabled without resetting the device, the HWD timer 110 continues to count down. Since the required security property verification does not occur, the HWD timer 110 expires without being fed, resulting in a timeout at step (3). Upon expiration, the HWD timer 110 generates a watchdog interrupt 115, which triggers a mandatory remediation action, such as a device reset or shutdown at step (4). In some embodiments, expiration of the HWD timer further results in reporting of a security violation to a user or administrator, for example via a notification indicating that the security property check has been disabled or bypassed.

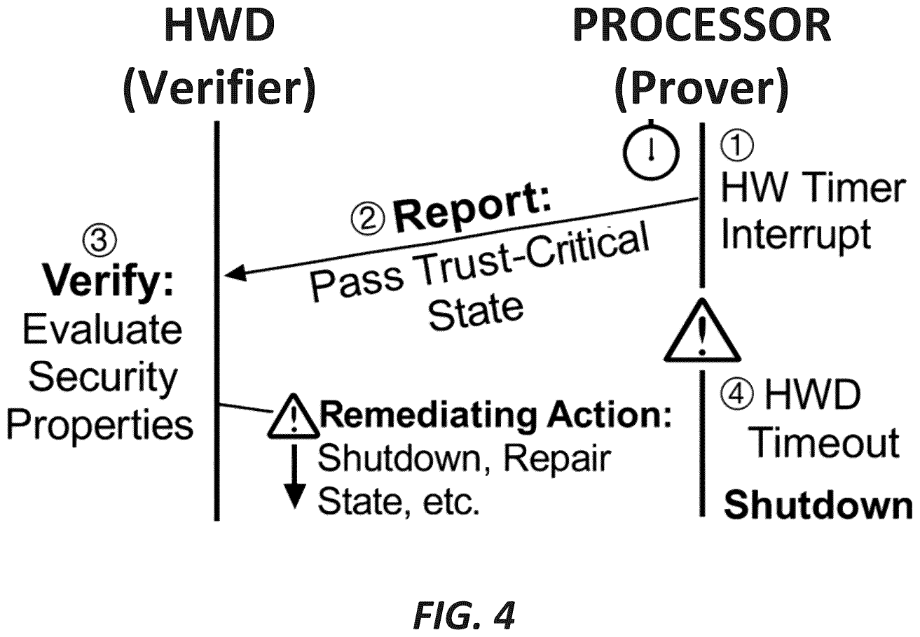

FIG. 4 illustrates an example timing diagram corresponding to a scenario in which one or more security properties are violated. As in the previously described scenarios, the illustrated timing sequence occurs after the HWD timer 110 has been enabled during secure boot and its countdown has commenced. At step (1), a hardware timer 120 triggers an NMI 125 requesting verification of the predefined security properties 140. In this scenario, the processor is under attack, resulting in an unauthorized change to hardware or execution state. Unlike the bypass scenario described with reference to FIG. 3, the attacker does not disable or bypass the interrupt timer 120, and the NMI 125 is successfully generated. At step (2), the processor 100 services the NMI 125 by ceding execution control to an interrupt handler and reporting its current operational state 130. At step (3), the interrupt handler evaluates the processor state 130 and memory contents by checking the predefined logical security properties 140. In this scenario, the interrupt handler detects a violation of one or more security properties 140 due to the altered processor state 130. In certain implementations, detecting the violation may directly trigger remediation actions. Because a security property violation is detected, the interrupt handler deliberately refrains from servicing, or “feeding,” the HWD timer 110. As a result, the HWD timer 110 continues to count down without being reset. At step (4), upon expiration of the HWD timer 110 without being fed, the HWD initiates one or more remedial actions. In some embodiments, these actions include notifying a user or administrator of the detected violation and restoring the device to a secure state, such as by resetting the processor 100 or otherwise preventing continued operation in an untrusted state.

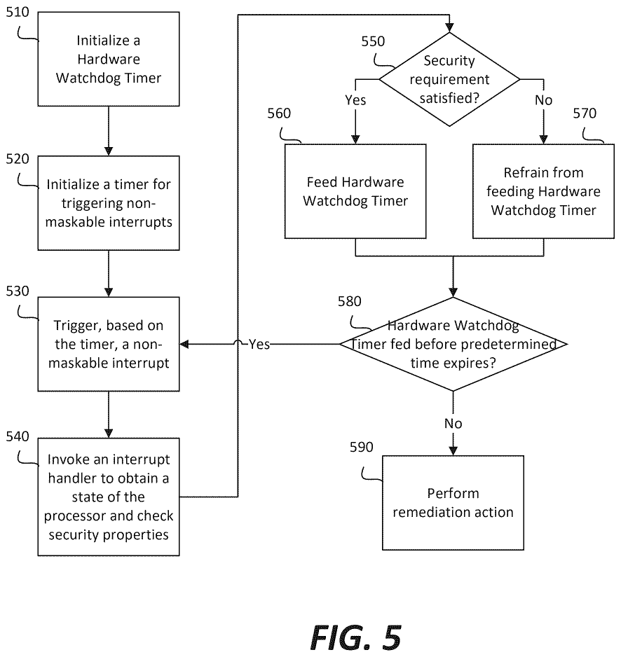

FIG. 5 is a flow diagram illustrating a hardware watchdog assisted security property enforcement process, according to particular embodiments. The process may begin at step 510, where a computing system may initialize a hardware watchdog timer that is configured to perform a remedial action unless the hardware watchdog timer is reset by a security confirmation signal before a predetermined time period expires. At step 520, the system may initialize a timer for triggering non-maskable interrupts at predetermined intervals. At step 530, the system may trigger, based on the timer, a first non-maskable interrupt before the predetermined time period of the hardware watchdog timer expires. At step 540, the system may invoke an interrupt handler to handle the first non-maskable interrupt. The interrupt handler may be configured to obtain a state of the processor and check a set of predefined logical security properties against the state of the processor. At step 550, the interrupt handler may determine whether a security requirement is satisfied or unsatisfied. Upon a determination that the security requirement is satisfied, the interrupt handler at step 560 may send a security confirmation signal to reset (or “feed”) the hardware watchdog timer, thereby preventing the remedial action from being performed. Conversely, upon a determination that the security requirement is unsatisfied, the interrupt handler at step 570 may refrain from sending the confirmation signal to the hardware watchdog timer, thereby allowing the hardware watchdog timer to perform the remedial action upon expiration of the predetermined time period. At step 580, the hardware watchdog timer may determine whether it has been fed before the predetermined time period expires. If so, the computing system may continue to operate normally, and the process may repeat from step 530, where another non-maskable interrupt is triggered according to the schedule defined by the timer to invoke another security check. On the other hand, if the hardware watchdog timer expires without being fed, the system at step 590 may perform one or more remediation actions.

The disclosed approach provides a hardware-watchdog-assisted mechanism for enforcing security properties on processors using only standard on-chip hardware. First, the approach enables robust enforcement of security properties without requiring custom hardware modifications, distinguishing it from prior remote attestation and hardware-assisted enforcement techniques that depend on specialized or additional hardware components. Second, the approach employs symptom-based detection by evaluating the effects of potential security breaches on the processor state rather than targeting specific vulnerabilities. This enables detection of unknown or previously unanticipated security flaws, including security property violations arising from diverse root causes. Third, the approach is generic and broadly applicable, relying solely on a standard hardware watchdog timer and remaining independent of processor architecture and operating system, thereby supporting deployment across a wide range of platforms.

The embodiments described thus far rely primarily on logic-based evaluations of security properties 140 to identify anomalies in system behavior. As an alternative or additional approach for detecting anomalies, machine-learning-based methods may also be employed. Machine-learning (ML) models offer the potential to identify subtle or complex deviations in behavior that may not be easily captured by rule-based logic alone. For example, ML models may be trained to detect malicious firmware, malware, adversarial inputs, and/or hardware trojans. As will be described in further detail below, an ML model may be used differently in different embodiments. For example, an ML-based anomaly detector may be used (i) to detect anomalies and feed the watchdog timer, (ii) to trigger logging but not feed the watchdog timer (i.e., only logic-based rules are used to determine whether the watchdog timer should be fed), or (iii) provide additional signal for the rule-based logic to assess whether an anomaly has occurred.

A significant challenge in applying ML to security applications is the lack of training data representing both known and unknown behavior of a compromised system. Generally, ML models are trained on historical data and, once deployed, tend to be static and difficult to update. This makes them inherently reactive rather than proactive, resulting in a persistent lag behind the constantly evolving threat landscape. In particular, zero-day attacks (e.g., novel exploits targeting previously unknown vulnerabilities) pose a unique problem because, by definition, they are absent from existing datasets and therefore cannot be captured during training. As a result, ML models trained solely on known threats may struggle to detect new or emerging attack vectors, limiting their effectiveness in real-world security scenarios.

To address this issue, particular embodiments train ML models exclusively on benign operational data (i.e., system state while the processor is operating in a secure state) to learn a statistical or behavioral baseline of the processor's normal functioning. The model is then used to detect deviations from this learned baseline, flagging them as potential anomalies without needing prior knowledge of specific attack signatures, which may not be available yet at the time of ML training. This approach enhances adaptability to unknown threats and reduces reliance on continually updated threat datasets.

In particular embodiments, training data for an ML model may be gathered while a processor is executing intended operations or applications. Relevant processor states, such as performance counters (e.g., measurements of critical, security-related runtime metrics), may be recorded and used as training data while the processor is in a secure state. These counters can either be hardware performance counters, built-in special registers in more powerful devices, or user-defined software counters in resource constrained devices. These counters will aggregate the runtime behavior of key performance metrics in devices (e.g., completed instructions, branches taken, etc.). The specific metrics that these counters will aggregate for detection will be selected based on feature significance, consistency, F1 score, and overhead of the resulting detector.

Support vector machines (SVM) are a resource-efficient family of machine learning classifiers. SVMs are trained to mathematically identify a hyperplane to optimally separate different classes. To produce non-linear decision boundaries, the training data is often projected to a higher-dimensional space, which is referred to as the feature space. In this higher-dimensional feature-space, a straight hyperplane can be identified to separate training classes that is non-linear in the original space. Once this straight separating hyperplane is defined, classification involves only projection of the input to the features space (i.e., multiplication and addition) and a comparison with a linear decision boundary, making SVM well suited to resource-constrained processors.

Since all of the training data are of one class (i.e., they would all be labeled as benign data), the ML model may be one that is designed to learn to recognize one classification. For example, the ML model in particular embodiments may be a One-Class Support Vector Machine (OC-SVM) detector trained to detect characteristics of a system's state that correspond to a benign operational scenario. The training methodology for OC-SVM involves learning a decision boundary that best captures the region where the majority of the training data—assumed to belong to a single class—resides. Unlike traditional SVMs that separate two or more classes, an OC-SVM is trained solely on “normal” data, with the goal of distinguishing it from all other potential “anomalous” inputs. During training, the data is first mapped into a vector/embedding in a high-dimensional feature space. The algorithm then identifies a hyperplane that maximizes the margin between the data and the origin, effectively enclosing most of the data points while allowing for some deviations. The result is a decision function that can classify new data as being either similar to the training distribution (inliers) or significantly different (outliers). This makes OC-SVM particularly useful for anomaly detection tasks. In addition to a binary decision, the magnitude of the distance between the state vector/embedding and the learned boundary may also be treated as a confidence score of how likely the machine's state is normal or anomalous (i.e., the farther away, the more likely the machine is operating in an anomalous state, indicative of a compromised system).

OC-SVM offers several advantages for anomaly detection in embedded systems, particularly in resource-constrained environments like low-end processors. As discussed, one of its primary benefits is that it only requires benign data during training, making it well-suited for cybersecurity scenarios where examples of malicious behavior are unavailable, impractical to obtain, or too varied to capture comprehensively. This allows the OC-SVM to learn a representation of normal system behavior without needing access to adversarial examples. Additionally, the OC-SVM provides a decision boundary that is straightforward to tune using parameters that control the trade-off between the fraction of training errors and the model's generalization capacity. This tunability is especially useful for minimizing false positives in safety-critical applications, where incorrectly flagging benign behavior as malicious could lead to unnecessary system resets or degraded performance. From a computational perspective, OC-SVMs are lightweight and resource-efficient, making them practical for integration into a variety of applications.

Once trained, the OC-SVM (or another suitable machine learning model for anomaly detection) may be stored in the processor's memory and configured to be invoked by the aforementioned interrupt handler. For example, upon receiving a non-maskable interrupt (NMI) 125, the interrupt handler requests the processor 100 for security-relevant system state information. This may include, for example, performance counters that measure key, security-related metrics that serve as features for the SVM-based anomaly detector. They are configured in protected memory that cannot be modified outside of the OS. The specific metrics may be selected based on consistency and ability to detect the particular types of attacks of interest (e.g., malicious firmware, HW trojan, malware, and adversarial inputs). Additionally or alternatively, the information requested may include, e.g., program counters (PC), link registers (LR), various configuration registers, and any other relevant data. The interrupt handler uses the OC-SVM to convert the state information into a feature vector, which is then evaluated by the OC-SVM to assess whether the current system state is normal or anomalous. If the OC-SVM determines that the current state is normal/benign, the interrupt handler proceeds to feed the HWD 110, such as via a watchdog-feed NMI to inform the HWD 110 that no anomalous event has been detected, thereby preventing a system reset and allowing the processor 100 to continue its normal operation. However, if the OC-SVM classifies the state as anomalous—indicating a potential compromised system—the interrupt handler would withhold the watchdog feed. This causes the HWD 110 to time out, triggering a system reset or other remedial actions, such as notifying the user of a suspected security event.

While the preceding embodiments describe the use of an OC-SVM as one example of an ML-based anomaly detector, other suitable machine learning models may be employed instead. For instance, the model may be an autoencoder. In particular embodiments, training an autoencoder involves teaching the autoencoder to reconstruct its input data as accurately as possible. The training process may begin with collecting representative data that reflects normal or benign system behavior. The autoencoder architecture may consist of an encoder, which compresses the input into a latent representation, and a decoder, which attempts to reconstruct the original input from this representation. During training, the autoencoder minimizes a loss function that quantifies the difference between the original input and its reconstruction. By adjusting its internal parameters to reduce this reconstruction loss via back propagation, the autoencoder learns to capture the underlying patterns of normal data. Once trained, the model can be used for anomaly detection by evaluating how well it reconstructs new inputs: a low reconstruction loss indicates normal behavior, while a high loss suggests a potential anomaly.

During inference, the autoencoder attempts to reconstruct a given processor state based on its learned representation. The difference between the input to the autoencoder and the reconstructed output (i.e., the reconstruction loss) serves as an indicator of how typical the input is. A low reconstruction loss suggests that the state is consistent with previously observed benign behavior, while a high loss indicates a potential anomaly, such as system compromise or unexpected behavior. Autoencoders, like OC-SVMs, have the advantage of not requiring anomalous training data, making them well-suited for unsupervised anomaly detection in resource-constrained environments.

In certain embodiments, the ML-based anomaly detector may be used in combination with one or more logic-based detection techniques. In some implementations, both ML-based and logic-based anomaly detectors may be invoked concurrently, whereas in other implementations they may be invoked separately and at different frequencies. For example, because ML-based analysis may be computationally more expensive than deterministic logic-based techniques, the ML-based detector may be executed at a lower frequency than the logic-based counterpart. For example, the interrupt timer that triggers an ML-based anomaly detector may have a longer delay between interrupts than the interrupt timer that triggers a logic-based anomaly detector.

In embodiments employing both logic-based and machine-learning-based anomaly detectors, the logic-based anomaly detector is relied upon to determine whether the hardware watchdog timer is serviced due to its deterministic behavior and low computational overhead. The logic-based detector applies predefined rules to evaluate security properties of the system state and is therefore suitable for time-critical enforcement actions, including feeding the hardware watchdog timer and triggering remediation actions. By contrast, results produced by the machine-learning-based anomaly detector may exhibit a higher false-positive rate and are therefore not used, in some embodiments, to determine whether the hardware watchdog timer is serviced. Instead, the machine-learning-based detector is used to flag potential anomalies and to trigger auxiliary actions, such as event logging, recording register values, capturing memory snapshots, or otherwise preserving diagnostic information. This approach supports human-in-the-loop analysis and forensic inspection while avoiding unnecessary system resets that could be caused by false positives generated by the machine-learning-based detector. In this manner, the machine-learning-based detector provides informational and diagnostic insight without directly dictating enforcement actions that could disrupt system operation. However, in other embodiments, when the machine-learning-based detector demonstrates sufficient reliability or when its false-positive rate is reduced below a predetermined threshold, results produced by the machine-learning-based detector may additionally be used to influence enforcement decisions, including servicing the hardware watchdog timer.

In certain embodiments, rather than relying exclusively on either a logic-based or a machine-learning-based anomaly detector to determine whether to feed a hardware watchdog timer, the secured processor employs a hybrid detection strategy that leverages both techniques. The detectors may be invoked sequentially or in parallel, depending on a desired balance between detection sensitivity, computational cost, and resource efficiency, with such tradeoffs configurable by a system designer. In one example implementation, an interrupt handler first invokes a ML-based detector to assess the system state. If the ML-based detector detects a possible anomalous event and/or produces an inconclusive result, the handler may then invoke the logic-based detector to perform a secondary, deterministic verification. This staged evaluation conserves computational resources by limiting use of both detectors to cases where additional scrutiny is warranted. In another embodiments, the logic-based and ML-based detectors are invoked concurrently, and their respective outputs are combined to inform a final enforcement decision. For example, only when both detectors independently confirm anomalous behavior would the handler refrain from feed the watchdog timer to trigger a remediation action. The exact criteria for deciding whether to feed the watchdog timer based on the outputs of the two types of detectors may depend on application-specific risk tolerance, performance constraints, and reliability requirements.

As demonstrated, HWD-assisted property enforcement provides a robust method for enforcing security properties without the need for custom hardware modifications, unlike prior work related to remote attestation and hardware property enforcement. In addition, the proposed approach employs symptom-based detection, focusing on the impacts of potential security breaches on the processor state rather than targeting specific vulnerabilities. This facilitates the detection of unknown vulnerabilities or security bugs. Lastly, HWD-assisted property enforcement is generic, relying only on standard hardware components (i.e., a HWD timer) with no dependence on architecture or operating system. This allows for broad application across different platforms.

Experiments have shown that the disclosed invention is capable of detecting a variety of attacks, including electromagnetic fault injection (EMFI) attacks and software-based attacks such as buffer overflow attacks. EMFI attacks induce transient faults through electromagnetic disturbances, leading to instruction skips, register corruption, or unintended state changes that may evade signature-based or software-only defenses. Similarly, buffer overflow attacks may corrupt memory or control flow without immediately disabling system execution. The invention detects such attacks by periodically verifying predefined security properties associated with the processor state, including relationships among registers, memory contents, and execution context. Experiments have shown that deviations in system state caused by EMFI or buffer overflow attacks result in detectable violations of these security properties. Either due to the attack itself or upon detecting state anomalies, the watchdog timer expires, resulting in the appropriate remedial or logging action being triggered. Because detection is based on the observable effects of an attack rather than the specific attack mechanism, the disclosed approach enables robust, symptom-based detection of both physical and software-based attacks that would otherwise be difficult to detect using conventional techniques.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

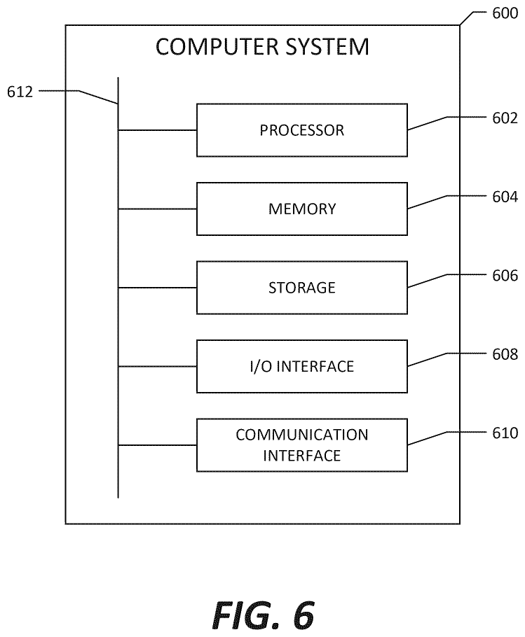

FIG. 6 illustrates an example computer system 600 that may be useful in performing one or more of the foregoing techniques as presently disclosed herein. In particular embodiments, one or more computer systems 600 perform one or more steps of one or more methods described or illustrated herein. In particular embodiments, one or more computer systems 600 provide functionality described or illustrated herein. In particular embodiments, software running on one or more computer systems 600 performs one or more steps of one or more methods described or illustrated herein or provides functionality described or illustrated herein. Particular embodiments include one or more portions of one or more computer systems 600. Herein, reference to a computer system may encompass a computing device, and vice versa, where appropriate. Moreover, reference to a computer system may encompass one or more computer systems, where appropriate.

This disclosure contemplates any suitable number of computer systems 600. This disclosure contemplates computer system 600 taking any suitable physical form. As example and not by way of limitation, computer system 600 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a digital assistant (PDA), a server, a tablet computer system, an augmented/virtual reality device, or a combination of two or more of these. Where appropriate, computer system 600 may include one or more computer systems 600; be unitary or distributed; span multiple locations; span multiple machines; span multiple data centers; or reside in a cloud, which may include one or more cloud components in one or more networks. Where appropriate, one or more computer systems 600 may perform without substantial spatial or temporal limitation one or more steps of one or more methods described or illustrated herein.

As an example, and not by way of limitation, one or more computer systems 600 may perform in real time or in batch mode one or more steps of one or more methods described or illustrated herein. One or more computer systems 600 may perform at different times or at different locations one or more steps of one or more methods described or illustrated herein, where appropriate. In particular embodiments, computer system 600 includes a processor 602, memory 604, storage 606, an input/output (I/O) interface 608, a communication interface 610, and a bus 612. Although this disclosure describes and illustrates a particular computer system having a particular number of particular components in a particular arrangement, this disclosure contemplates any suitable computer system having any suitable number of any suitable components in any suitable arrangement.

As used herein, the term “processor” (or “processors”) refers broadly to any device, circuit, or combination of hardware and/or firmware configured to execute instructions, process data, control operations, and/or perform logical, computational, or decision-making functions. A processor may include, without limitation, a microprocessor, microcontroller (MCU), central processing unit (CPU), graphics processing unit (GPU), digital signal processor (DSP), application-specific integrated circuit (ASIC), field-programmable gate array (FPGA), system-on-chip (SoC), programmable logic device, or any other programmable or fixed-function processing circuitry. A processor may include one or more processing cores and may operate alone or in combination with other processors. Execution of instructions may be implemented using hardware, firmware, software, or any combination thereof.

In particular embodiments, processor 602 includes hardware for executing instructions, such as those making up a computer program. As an example, and not by way of limitation, to execute instructions, processor 602 may retrieve (or fetch) the instructions from an internal register, an internal cache, memory 604, or storage 606; decode and execute them; and then write one or more results to an internal register, an internal cache, memory 604, or storage 606. In particular embodiments, processor 602 may include one or more internal caches for data, instructions, or addresses. This disclosure contemplates processor 602 including any suitable number of any suitable internal caches, where appropriate. As an example, and not by way of limitation, processor 602 may include one or more instruction caches, one or more data caches, and one or more translation lookaside buffers (TLBs). Instructions in the instruction caches may be copies of instructions in memory 604 or storage 606, and the instruction caches may speed up retrieval of those instructions by processor 602.

Data in the data caches may be copies of data in memory 604 or storage 606 for instructions executing at processor 602 to operate on; the results of previous instructions executed at processor 602 for access by subsequent instructions executing at processor 602 or for writing to memory 604 or storage 606; or other suitable data. The data caches may speed up read or write operations by processor 602. The TLBs may speed up virtual-address translation for processor 602. In particular embodiments, processor 602 may include one or more internal registers for data, instructions, or addresses. This disclosure contemplates processor 602 including any suitable number of any suitable internal registers, where appropriate. Where appropriate, processor 602 may include one or more arithmetic logic units (ALUs); be a multi-core processor; or include one or more processors 602. Although this disclosure describes and illustrates a particular processor, this disclosure contemplates any suitable processor.

In particular embodiments, memory 604 includes main memory for storing instructions for processor 602 to execute or data for processor 602 to operate on. As an example, and not by way of limitation, computer system 600 may load instructions from storage 606 or another source (such as, for example, another computer system 600) to memory 604. Processor 602 may then load the instructions from memory 604 to an internal register or internal cache. To execute the instructions, processor 602 may retrieve the instructions from the internal register or internal cache and decode them. During or after execution of the instructions, processor 602 may write one or more results (which may be intermediate or final results) to the internal register or internal cache. Processor 602 may then write one or more of those results to memory 604. In particular embodiments, processor 602 executes only instructions in one or more internal registers or internal caches or in memory 604 (as opposed to storage 606 or elsewhere) and operates only on data in one or more internal registers or internal caches or in memory 604 (as opposed to storage 606 or elsewhere).

One or more memory buses (which may each include an address bus and a data bus) may couple processor 602 to memory 604. Bus 612 may include one or more memory buses, as described below. In particular embodiments, one or more memory management units (MMUs) reside between processor 602 and memory 604 and facilitate accesses to memory 604 requested by processor 602. In particular embodiments, memory 604 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 604 may include one or more memories 604, where appropriate. Although this disclosure describes and illustrates particular memory, this disclosure contemplates any suitable memory.

In particular embodiments, storage 606 includes mass storage for data or instructions. As an example, and not by way of limitation, storage 606 may include a hard disk drive (HDD), a floppy disk drive, flash memory, an optical disc, a magneto-optical disc, magnetic tape, or a Universal Serial Bus (USB) drive or a combination of two or more of these. Storage 606 may include removable or non-removable (or fixed) media, where appropriate. Storage 606 may be internal or external to computer system 600, where appropriate. In particular embodiments, storage 606 is non-volatile, solid-state memory. In particular embodiments, storage 606 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 606 taking any suitable physical form. Storage 606 may include one or more storage control units facilitating communication between processor 602 and storage 606, where appropriate. Where appropriate, storage 606 may include one or more storages 606. Although this disclosure describes and illustrates particular storage, this disclosure contemplates any suitable storage.

In particular embodiments, I/O interface 608 includes hardware, software, or both, providing one or more interfaces for communication between computer system 600 and one or more I/O devices. Computer system 600 may include one or more of these I/O devices, where appropriate. One or more of these I/O devices may enable communication between a user and computer system 600. As an example, and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 608 for them. Where appropriate, I/O interface 608 may include one or more device or software drivers enabling processor 602 to drive one or more of these I/O devices. I/O interface 608 may include one or more I/O interfaces 608, where appropriate. Although this disclosure describes and illustrates a particular I/O interface, this disclosure contemplates any suitable I/O interface.

In particular embodiments, communication interface 610 includes hardware, software, or both providing one or more interfaces for communication (such as, for example, packet-based communication) between computer system 600 and one or more other computer systems 600 or one or more networks. As an example, and not by way of limitation, communication interface 610 may include a network interface controller (NIC) or network adapter for communicating with an Ethernet or other wire-based network or a wireless NIC (WNIC) or wireless adapter for communicating with a wireless network, such as a Wi-Fi network. This disclosure contemplates any suitable network and any suitable communication interface 610 for it.

As an example, and not by way of limitation, computer system 600 may communicate with an ad hoc network, an area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 600 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 600 may include any suitable communication interface 610 for any of these networks, where appropriate. Communication interface 610 may include one or more communication interfaces 610, where appropriate. Although this disclosure describes and illustrates a particular communication interface, this disclosure contemplates any suitable communication interface.

In particular embodiments, bus 612 includes hardware, software, or both coupling components of computer system 600 to each other. As an example, and not by way of limitation, bus 612 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 612 may include one or more buses 612, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate. The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

Numerical ranges recited in this application should be construed to be inclusive of the end points of the stated ranges. Particular axes, such as one or more lateral and/or longitudinal axes, which may be omitted herein in some illustrations, should be construed to exist in every illustration or situation where it is referred to.

What is claimed:

1. A method for detecting hardware anomalies in a processor, the method comprising:
initializing a hardware watchdog timer configured to perform a remedial action unless the hardware watchdog timer is reset by a security confirmation signal before a predetermined time period expires;
initializing a timer for triggering non-maskable interrupts at predetermined intervals;
triggering, based on the timer, a first non-maskable interrupt before the predetermined time period of the hardware watchdog timer expires;
invoking an interrupt handler to handle the first non-maskable interrupt, wherein the interrupt handler is configured to:
obtain a state of the processor;
check a set of predefined logical security properties against the state of the processor to determine whether a security requirement is satisfied or unsatisfied;
upon a determination that the security requirement is satisfied, send the security confirmation signal to reset the hardware watchdog timer, thereby preventing the remedial action from being performed; and
upon a determination that the security requirement is unsatisfied, refrain from sending the confirmation signal to the hardware watchdog timer, thereby allowing the hardware watchdog timer to perform the remedial action upon expiration of the predetermined time period.

2. The method of claim 1, wherein the hardware watchdog timer is enabled during startup of the processor and cannot be disabled during operation of the processor.

3. The method of claim 1, wherein the remedial action comprises a forced reset of the processor.

4. The method of claim 1, wherein the security confirmation signal is sent by the interrupt handler to the hardware watchdog timer via a second non-maskable interrupt.

5. The method of claim 1, wherein the security properties are configurable and stored in protected memory accessible by the processor.

6. The method of claim 1, further comprising:
invoking, at predetermined second intervals, a machine-learning model to determine whether the processor is in a secure state or an anomalous state; and
in response to the machine-learning model determining that the processor is in an anomalous state, logging data associated with the processor.

7. The method of claim 6, wherein the machine-learning model is trained using training data obtained from one or more processors operating in a secure state and not using any training data from any processor operating in an anomalous state.

8. The method of claim 6, wherein the machine-learning model is a one-class support vector machine.

9. The method of claim 6, wherein the machine-learning model is an autoencoder.

10. The method of claim 6, wherein the predetermined second intervals for invoking the machine-learning model has a lower frequency than the predetermined intervals for triggering the non-maskable interrupts.

11. The method of claim 1, wherein the interrupt handler is further configured to determine whether the security requirement is satisfied or unsatisfied by using a machine-learning model to determine whether the processor is in a secure state or an anomalous state.

12. A system comprising:
a hardware watchdog timer configured initialize upon startup of the system and to perform a remedial action unless the hardware watchdog timer is reset by a security confirmation signal before a predetermined time period expires;
one or more non-transitory computer-readable storage media including instructions; and
one or more processors coupled to the one or more non-transitory computer-readable storage media, the one or more processors configured to execute the instructions to:
initialize a timer for triggering non-maskable interrupts at predetermined intervals;
trigger, based on the timer, a first non-maskable interrupt before the predetermined time period of the hardware watchdog timer expires;
invoke an interrupt handler to handle the first non-maskable interrupt, wherein the interrupt handler is configured to:
obtain a state of the one or more processors;
check a set of predefined logical security properties against the state of the one or more processor to determine whether a security requirement is satisfied or unsatisfied;
upon a determination that the security requirement is satisfied, send the security confirmation signal to reset the hardware watchdog timer, thereby preventing the remedial action from being performed; and
upon a determination that the security requirement is unsatisfied, refrain from sending the confirmation signal to the hardware watchdog timer, thereby allowing the hardware watchdog timer to perform the remedial action upon expiration of the predetermined time period.

13. The system of claim 12, wherein the hardware watchdog timer cannot be disabled during operation of the one or more processors.

14. The system of claim 12, wherein the remedial action comprises a forced reset of the one or more processor.

15. The system of claim 12, wherein the security confirmation signal is sent by the interrupt handler to the hardware watchdog timer via a second non-maskable interrupt.

16. The system of claim 12, wherein the one or more processors are further configured to execute the instructions to:
invoke, at predetermined second intervals, a machine-learning model to determine whether the processor is in a secure state or an anomalous state; and
in response to the machine-learning model determining that the processor is in an anomalous state, log data associated with the processor.

17. The system of claim 16, wherein the machine-learning model is trained using training data obtained from one or more processors operating in a secure state and not using any training data from any processor operating in an anomalous state.

18. The system of claim 16, wherein the machine-learning model is a one-class support vector machine.

19. The system of claim 16, wherein the machine-learning model is an autoencoder.

20. The system of claim 16, wherein the predetermined second intervals for invoking the machine-learning model has a lower frequency than the predetermined intervals for triggering the non-maskable interrupts.
